(19) United States
(12) Patent Application Publication
(10) Pub. No.: US 2008/0166437 A1
(43) Pub. Date: Jul. 10, 2008

(54) Methods of reducing pests and treating gastrointestinal nematode infections

(76) Inventors: Erin N. Rosskopf, Fort Pierce, FL (US); Leonard L. Therrien, Sebastian, FL (US); Scott T. Adkins, Fort Pierce, FL (US); Fanny Iriarte, Vero Beach, FL (US); Joyce G. Foster, Beaver, WV (US); Nancy Kokalis-Burelle, Vero Beach, FL (US)

Correspondence Address: USDA, ARS, OTT, 5601 SUNNYSIDE AVE, RM 4-1159, BELTSVILLE, MD, 20705-5131, US

(21) Appl. No.: 12/006,523

(22) Filed: Jan. 3, 2008

Related U.S. Application Data
(60) Provisional application No. 60/878,517, filed on Jan. 4, 2007.
(60) Provisional application No. 60/878,516, filed on Jan. 4, 2007.

(51) Int. Cl. A01N 65/00; A01P 17/00

(52) U.S. Cl. 424/736

(57) ABSTRACT

Methods for reducing pests (e.g., nematodes, oomycetes, fungi, viruses) in an object or area by applying to the object or area a pest reducing effective amount of a composition containing hydrogen peroxide, orange terpene oil, orange valencia oil, at least one non-ionic emulsifier, distilled water or deionized water, and optionally hydrogen peroxide. Methods for treating gastrointestinal nematode infection in ruminant animals by administering to a ruminant animal in need of such treatment a therapeutically effective amount of a composition containing orange terpene oil, orange valencia oil, at least one non-ionic emulsifier, distilled water or deionized water, and optionally hydrogen peroxide.

### REFERENCE TO RELATED APPLICATION

This application claims the benefit of U.S. Provisional Application No. 60/878,517, filed 4 Jan. 2007, which is incorporated herein by reference in its entirety.

### BACKGROUND OF THE INVENTION

The present invention relates to methods for reducing pests in an object or area by applying to the object or area a pest reducing effective amount of a composition containing orange terpene oil, orange valencia oil, at least one non-ionic emulsifier, distilled water or deionized water, and optionally hydrogen peroxide. Additionally, the present invention relates to methods for treating gastrointestinal nematode infection in ruminant animals by administering to a ruminant animal in need of such treatment a therapeutically effective amount of a composition containing orange terpene oil, orange valencia oil, at least one non-ionic emulsifier, distilled water or deionized water, and optionally hydrogen peroxide.

Methyl bromide is the chemical fumigant currently utilized to control fungi, straminopiles (oomycetes), nematodes, weeds, and insects in soil that is used for the production of high value agricultural crops such as strawberries, tomatoes, peppers, orchard crops, and vine crops. In 1992, methyl bromide was implicated as an ozone-depleting compound and subsequently the production levels of methyl bromide were frozen at the 1991 production levels. Methyl bromide was targeted for a 5-year phase-out beginning in the year 2000 and was to be completely phased out by the year 2005 in accordance with the Montreal Protocol. However, methyl bromide continues to be available for those uses that have not found a technically or economically feasible alternative and these uses are allowed through a Critical Use Exemption. The agricultural producing states most affected by this phase-out are Florida and California, which produce the majority of the tomatoes, peppers, strawberries, cut flowers, turf/sod, tobacco, melons, pineapples, orchard crops (e.g., peaches, citrus), and vine crops (e.g., grapes) grown in the United States. The aforementioned crops are the largest consumers of methyl bromide and other EPA registered fumigants for soil fumigation purposes. As methyl bromide is phased out, current crop yields are expected to be reduced due to increased pest pressure in non-fumigated soil.

There currently exist only a few EPA registered and frequently studied methyl bromide alternatives: 1,3-dichloropropene, chloropicrin, methane sodium and potassium, dazomet, methyl iodide, propargyl bromide, sodium azide, and Enzone (EPA, Methyl Bromide Web Page); these are commonly applied as mixtures of two or more of the individual compounds in order to attempt to produce a more broad spectrum product. None of these EPA registered potential alternatives are drop-in replacements for methyl bromide based on performance or economics (drop-in replacement means that methodology, equipment, production system, etc., do not have to be changed significantly and that a comparable amount of material can be used for the same targets; i.e., the material is applied at nearly the same rate and with the same equipment as methyl bromide). All the potential replacement compounds, and even methyl bromide, have worker exposure and environmental/degradation issues.

Nematodes, fungi and plant pathogenic straminopiles (oomycetes) in the aforementioned crops are among the targets of methyl bromide and any alternative to methyl bromide. Control of all plant pathogens and pests is extremely important to the production of these crops and sustained economic viability.

One goal of our research was to evaluate new compositions to determine their efficacy as replacements for methyl bromide.

A second goal was to evaluate new compositions for the control of gastrointestinal parasites that infect ruminants. Gastrointestinal nematode infection impairs animal performance and can lead to fatalities. Haemonchus contortus is one of the most important parasite species in small ruminants like sheep and goats because of its high prevalence and pathogenicity. Control of these parasitic infections is generally based on the strategic use of anthelmintic drugs. However, resistance of the main nematode species to these chemical substances is now a widespread phenomenon with multiresistant strains which resist all currently commercialized anthelmintics emerging worldwide. No new drugs for gastrointestinal parasite control in small ruminants are currently being developed; thus, there is a need for alternatives to conventional treatment.

### SUMMARY OF THE INVENTION

In accordance with the present invention there is provided a method for reducing pests in an object or area by applying to the object or area a pest reducing effective amount of a composition containing orange terpene oil, orange valencia oil, at least one non-ionic emulsifier, distilled water or deionized water, and optionally hydrogen peroxide.

Additionally, in accordance with the present invention there is provided a method for treating gastrointestinal nematode infection in ruminant animals by administering to a ruminant animal in need of such treatment a therapeutically effective amount of a composition containing orange terpene oil, orange valencia oil, at least one non-ionic emulsifier, distilled water or deionized water, and optionally hydrogen peroxide.

### BRIEF DESCRIPTION OF THE DRAWINGS

FIG. 1 shows phytotoxicity of composition EC1 (described below) on bell pepper. Only pathogen-free treatments were used to assess phytotoxicity. Treatments (as described below) include: 7=pre-drench only, 8=pre-drench and 15% post-transplant treatment, 9=pre-drench and 25% post-transplant treatment, 10=water control, 11=no pre-drench and 15% post-transplant treatment, 12=no pre-drench and 25% post-transplant treatment.

FIG. 2 shows phytotoxicity of composition EC1 on tomato. Only pathogen-free treatments were used to assess phytotoxicity. Treatments (as described below) include: 7=pre-drench only, 8=pre-drench and 15% post-transplant treatment, 9=pre-drench and 25% post-transplant treatment, 10=water control, 11=no pre-drench and 15% post-transplant treatment, 12=no pre-drench and 25% post-transplant treatment.

FIG. 3 shows impact of composition EC1 on Phytophthora blight of bell pepper. Treatments 1-6 represent Phytophthora-inoculated treatments. Treatments (as described below) include: 1=pre-drench only, 2=pre-drench and 15% post-transplant treatment, 3=pre-drench and 25% post-transplant treatment, 4=water control, 5=no pre-drench and 15% post-transplant treatment, 6=no pre-drench and 25% post-transplant treatment.

FIG. 4 shows impact of composition EC1 on bell pepper plant weight. Treatments 1-6 represent Phytophthora-inoculated treatments. Treatments 7-12 represent the pathogen-free treatments. Treatments (as described below) include: 1 &7=pre-drench only, 2&8=pre-drench and 15% post-transplant treatment, 3&9=pre-drench and 25% post-transplant treatment, 4&10=water control, 5& 11=no pre-drench and 15% post-transplant treatment, 6&12=no pre-drench and 25% post-transplant treatment.

FIG. 5 shows impact of composition EC1 on galling of tomato roots caused by Meloidogyne spp. Treatments 1-6 represent root-knot nematode-inoculated treatments. Treatments (as described below) include: 1=pre-drench only, 2=pre-drench and 15% post-transplant treatment, 3=pre-drench and 25% post-transplant treatment, 4=water control, 5=no pre-drench and 15% post-transplant treatment, 6=no pre-drench and 25% post-transplant treatment.

FIG. 6 shows impact of composition EC1 on egg production per gram of tomato root by Meloidogyne spp. Treatments 1-6 represent root-knot nematode-inoculated treatments. Treatments (as described below) include: 1=pre-drench only, 2=pre-drench and 15% post-transplant treatment, 3=pre-drench and 25% post-transplant treatment, 4=water control, 5=no pre-drench and 15% post-transplant treatment, 6=no pre-drench and 25% post-transplant treatment.

FIG. 7 shows impact of composition EC1 on embryonation and hatching of Haemonchus contortus eggs. Treatments A-D represent 48-hour treatments of isolated eggs. Treatments (as described below) include: A=water (control), B=2% EC1, C=10% EC1, and D=40% EC1.

FIG. 8 shows impact of composition EC1 on young red clover leaves two days post treatment. Treatments A-E represent increasing concentrations of EC1 applied as a mist to individual six-week-old seedlings. Treatments (as described below) include: A=3 mL of water (0% EC1), B=3 mL of 2% EC1, C=3 mL of 5% EC1, D=3 mL of 10% EC1, and E=3 mL of 20% EC1.

FIG. 9 shows impact of composition on alfalfa leaves two days post treatment. Treatments A-E represent increasing concentrations of EC1 applied as a mist to individual six-week-old seedlings. Treatments (as described below) include: A=3 mL of water (0% EC1), B=3 mL of 2% EC1, C=3 mL of 5% EC1, D=3 mL of 10% EC1, and E=3 mL of 20% EC1.

FIG. 10 shows impact of composition on orchardgrass two days post treatment. Treatments A-E represent increasing concentrations of EC1 applied as a mist to individual six-week-old seedlings. Treatments (as described below) include: A=3 mL of water (0% EC1), B=3 mL of 2% EC1, C=3 mL of 5% EC1, D=3 mL of 10% EC1, and E=3 mL of 20% EC1.

FIG. 11 shows impact of composition on forage chicory two days post treatment. Treatments A-E represent increasing concentrations of EC1 applied as a mist to individual six-week-old seedlings. Treatments (as described below) include: A=3 mL of water (0% EC1), B=3 mL of 2% EC1, C=3 mL of 5% EC1, D=3 mL of 10% EC1, and E=3 mL of 20% EC1.

### DETAILED DESCRIPTION OF THE INVENTION

The present invention concerns methods for reducing pests in an object or area by applying to the object or area a pest reducing effective amount of a composition containing orange terpene oil, orange valencia oil, at least one non-ionic emulsifier, distilled water or deionized water, and optionally hydrogen peroxide. The present invention also concerns methods for treating gastrointestinal nematode infection in ruminant animals (e.g., sheep, goats) by administering (orally) to a ruminant animal in need of such treatment a therapeutically effective amount of a composition containing orange terpene oil, orange valencia oil, at least one non-ionic emulsifier, distilled water or deionized water, and optionally hydrogen peroxide.

The present invention utilizes a highly potent non-toxic (to animals), environmentally friendly, composition. The composition described herein is composed of food grade material and comprises orange terpene oil, orange valencia oil, at least one non-ionic emulsifier (e.g. polysorbate 80), distilled water or deionized water (H₂O), and optionally hydrogen peroxide (H₂O₂) or source of activated oxygen which is well known in the art (e.g., oxygenated salt solution containing, for example, sodium chlorite). The disinfectant is very potent and is highly effective at killing plant pathogens including, but not limited to, nematodes and oomycetes. It is also very potent and is highly effective at killing gastrointestinal nematodes.

An advantage of the composition over other disinfectants is that it can be composed of entirely food grade materials while maintaining its high degree of potency against plant pathogens and gastrointestinal nematodes. The components of the composition described herein work synergistically against plant pathogens and gastrointestinal nematodes. Not to be bound by theory, it is believed that the orange valencia oil together with the other components weakens the plant pathogens (e.g., nematodes) and gastrointestinal nematodes, and makes them more vulnerable to H₂O₂.

In one embodiment, the composition further comprises oil of rosemary (e.g., CAS Number 8000-25-7, which can be obtained from Polarome International, Inc., 200 Theodore Conrad Drive, Jersey City, N.J. 07035).

Any non-ionic emulsifier can be used in the composition, including, but not limited to, alkyl polyethyleneoxy ethers, alkyl phenol polyethyleneoxy ethers, polyethyleneoxy amines, polyethyleneoxy fatty acids, and alkyl dimethyl amino oxides. In another embodiment, the composition comprising hydrogen peroxide, orange terpene oil, orange valencia oil, at least one non-ionic emulsifier, and distilled water or deionized water does not include an anionic surfactant or an amphoteric surfactant.

In one embodiment, the non-ionic emulsifier of the composition is polysorbate 80 (CAS Number 9005-65-6; polyoxyethylenesorbitan monooleate (TWEEN-80)).

In one embodiment, the composition comprises about 5% to about 40% (e.g., 5-40%) v/v orange terpene oil, about 5% to about 40% (e.g., 5-40%) v/v orange valencia oil, about 5% to about 50% (e.g., 5-50%) v/v non-ionic emulsifier, about 5% to about 80% (e.g., 5-80%)) v/v distilled or deionized water, and about 1.5% to about 8% (e.g., 1.5-8%) w/v hydrogen peroxide.

In one embodiment, the composition comprises about 60% (e.g., 60%) v/v distilled water, about 10% (e.g., 10%) v/v polysorbate 80, about 5% (e.g., 5%) v/v orange valencia oil, about 10% (e.g., 10%) v/v orange terpene oil, and about 15% (e.g., 15%) v/v of an about 35% (e.g., 35%) wt. % hydrogen peroxide solution (equivalent to about 5.35% (e.g., 5.35%) of H₂O₂. The composition can be used at full strength or can be diluted with water. Dilutions can range from about 1:1 to about 1:10,000 (e.g., 1:1 to 1:10,000).

The composition can be formulated, if desired, as a gel, spray, foam, or paste, or as a disinfecting wipe, using standard formulations known in the art as appropriate.

The composition can be made by mixing the components together using any known means. Preferably the components are mixed together sequentially. For example, the components are added in sequence to distilled water in the following order: orange terpene oil, orange valencia, then anionic surfactant (e.g., polysorbate 80). While being mixed at moderate speed, hydrogen peroxide is then added and mixed for approximately five minutes. In one preferred embodiment, the distilled water is kept between 90° and 100° Fahrenheit to facilitate the emulsification process.

The components can be obtained from any source. Preferably food grade components are used. As an example source, the orange terpene oil and orange valencia oil can be obtained from Polarome International, Inc. (200 Theodore Conrad Drive, Jersey City, N.J. 07035) (Orange Terpenes, CAS Number 68647-72-3, EINECS Number 232-433-8; Orange Oil Valencias, CAS Number 8008-57-9, EINECS Number 232-433-8)); the polysorbate 80 can be obtained from Spectrum Chemicals (14422 South San Pedro Street, Gardena, Calif. 90248); and they hydrogen peroxide from Solvay Chemicals Inc. (1632 Haden Road, Houston Tex. 77015) or from FMC corporation (1735 Market Street Philadelphia, Pa. 19103) (Durox®35%). The orange valencia oil can be derived from a cold press expression method which preserves viable anti-oxidants. In one embodiment, the orange valencia oil has at least about 1.4% (e.g., at least 1.4%) aldehydes.

In one embodiment, the orange valencia oil (CAS-No. 8008-57-9; EINECS Number 232-433-8; FEMA No., 2825, Tarrif No. 3301.12) is a cold pressed orange oil brasil valencia type oil having a maximum of about 0.1% or 0.01% citral (CAS-No. 5392-40-5), a maximum of about 0.4% linalool (CAS-No. 78-70-6), and a maximum of about 95% limonene (CAS-No. 5989-27-5) (Polarome International, Inc., 200 Theodore Conrad Drive, Jersey City, N.J. 07035). Physical and chemical properties include a flash point of about 450° C., vapor pressure at 20° C. of about 1 hPa; and a density at 20° C. of about 0.84 g/cm³, solubility in water about 0 g/L.

In one embodiment, the orange terpene oil is a cold pressed orange terpene oil (CAS-No. 68647-72-3; EINECS Number 232-433-8, FDA 21 CFR 182.20, FEMA No. 2633; having a maximum of about 96% limonene (CAS-No. 5989-27-5) (Polarome International, Inc., 200 Theodore Conrad Drive, Jersey City, N.J. 07035). Physical and chemical properties include a boiling point of about 160-250° C., a flash point of about 50° C., vapor pressure at 20° C. of about 1.2 hPa; and a density at 20° C. of about 0.85 g/cm³, solubility in water about 0.03 g/L.

While it is preferable to use only food grade components in the composition, other non-food grade components can also be added.

The composition described herein can include multiple surfactants, including, but not limited to nonionic surfactants such as nonylphenol ethoxylate, alcohol ethoxylates, octylphenol ethoxylate, coconut diethanolamide (cocoamide DEA), unspecified nonionic surfactant; anionic surfactants such as linear alkylbenzene sulfonate (dodecylbenzene sulfonate), alcohol sulfates (lauryl sulfates), alcohol ether sulfates (lauryl ether sulfates, laureth sulfates), sodium alkyl polyether sulfonate, alkyl polyglycosides, unspecified anionic surfactant, and soap; amphoteric surfactants such as, alkylbetaine, unspecified amphoteric surfactant; and cationic surfactants such as alkyl dimethyl benzyl ammonium chlorides, unspecified quaternary ammonium chlorides or compounds, alkylaryl dimethyl ammonium chloride, dimethyl ethyl benzyl ammonium chloride, ethylbenzene ammonium chloride, didecyl dimethyl ammonium chloride, octyl dimethyl ammonium chloride.

The composition can further comprise common builders that improve surfactant effectiveness, saponifiers, chelating agents, and/or other solvents, examples of such additives include, but are not limited to, acetic acid, hydrochloric acid, citric acid, sodium hydroxide, potassium hydroxide, carbonates sodium carbonate, sodium bicarbonate, pyrophosphates, polyphosphates, phosphate esters, orthophosphates, sodium metasilicate, sodium silicate, ethanolamines, carbonates, silicates, EDTA, STPP, and zeolites/PCA, isopropanol, methanol, ethanol, 2-butoxyethanol, diethylene glycol ethyl ether, diethylene glycol, monomethylether, 1-methoxy-2-propanol, 2-2-butoxyethyoxyethanol, d-limonene, pine oil, tall oil, ammonia (ammonium hydroxide), hydrocarbons, propylene glycol, ethylene glycol, or 1,3-propanediol.

Although not necessary, it is possible to employ other antimicrobial agents in the composition, for example quaternary ammonium compounds, phenols, alcohols, sodium hypochlorite, pine oil or other known antimicrobial oils. Examples of quaternary ammonium compounds include, but are not limited to alkyl dimethyl benzyl ammonium chlorides, unspecified quaternary ammonium chlorides or compounds, alkylaryl dimethyl ammonium chloride, dimethyl ethyl benzyl ammonium chloride, ethylbenzene ammonium chloride, didecyl dimethyl ammonium chloride, and octyl dimethyl ammonium chloride. Preferably the quaternary ammonium compound is present in the composition at 0.01-1%. Example phenols include, but are not limited to ortho-benzyl parachlorophenol, ortho-phenylphenol, and para-tertiary-amylphenol. Preferably the phenol is present in the composition at 2-5%. Examples of alcohols include but are not limited to isopropyl alcohol and ethanol. Preferably, sodium hypochlorite is present in the composition from 0.5-5%. Other exemplary antimicrobial agents include, but are not limited to, triclosan, cetyl pyridium chloride, domiphen bromide, zinc compounds, sanguinanine soluble pyrophosphates, fluorides, alexidine, octonidine, EDTA, and the like.

The non-toxic nature for animals of the composition described herein allows for its use not only in applications where the harshness of the composition is irrelevant, but also in applications more sensitive in nature, for example when treating plants (e.g., forage) and food stuff, and killing gastrointestinal nematodes (e.g., in ruminants).

Application of the composition in accordance with the present invention may be effected by a number of different procedures as are currently routinely employed for soil and structural treatments with, for example, methyl bromide. Thus, for example, the composition may be applied to the soil by tractor mounted injectors on tynes, manually in canisters and via an existing irrigation system or as a gas through lay flat tubing; furthermore, for example, the composition may be applied by drip irrigation, shanking in, spray/rototill, or overhead sprinklers. The composition may be dissolved in suitable solvents (e.g., water, alcohols, ethers, petroleum based solvents) and/or emulsified to assist in dispersion of the material during the treatment of, for example, soil and agricultural substances. The composition may be heated to form a gas. Furthermore, it is contemplated as within the scope of the invention to apply the composition with other fumigants (e.g., nematicides) or other agricultural chemicals, for example methyl bromide, chloropicrin, Inline® or Telone® C-17. The composition may be added to feed material or orally administered as a liquid for the treatment of gastrointestinal parasites (e.g., in ruminants).

A wide range of application rates of the composition may be suitable in accordance with the present invention. Those working in this field would of course be readily able to determine in an empirical manner the optimum rates of application for any given combination of plants (e.g., crops, animal forage), soils, structures, and the target organisms to be killed or eliminated. The amount of the composition used will be at least an effective amount to reduce pests. The term “pest reducing effective amount,” as used herein, means the minimum amount of the composition needed to reduce the number of pests (e.g., nematodes) in a ruminant animal, or in an object or area (e.g., soil, structures, plants, or agricultural commodities such as grain or wood). As would be readily appreciated by a person skilled in the art, the delivery of the composition can be calculated in terms of the active ingredient applied per unit area. Of course, the precise amount of the composition needed will vary in accordance with the type of area or object to be treated; the number of days of effectiveness needed; and the environment in which the area or object is located. The precise amount of the composition can easily be determined by one skilled in the art given the teaching of this application. Other compounds may be added to the composition provided they do not substantially interfere with the intended activity of the composition; whether or not a compound interferes with activity can be determined, for example, by the procedures described below. For areas or objects, such other compounds include, for example, pesticides or chemicals such as chloropicrin, metam sodium, 1,3-dichloropropene, propylene oxide, basamid, alkyl iodides), generally in ratios in the range of about 1:10 to about 10:1, in order to enhance efficacy or improve use economics. Treatments for gastrointestinal parasites may be included with cultural practices (e.g., herd, pasture and soil management) used to minimize infestations and knowledge of life-cycles of parasites used to target timing of applications to the most susceptible life phase.

A wide range of timing of application of the composition may be suitable in accordance with the present invention. Those working in this field would of course be readily able to determine in an empirical manner the optimum timing of application for any given combination of crops, soils, animals (e.g., in ruminants), structures, and the target organisms to be killed or eliminated. For example, the timing of application may be pre- or post-bedding, pre-transplant, pre-seed, or pre-plant. Preferably the timing of application to soil is pre-bedding, pre-transplant, pre-seed, or pre-plant in order to prevent plant infections by nematodes, oomycetes, and fungi. The composition may be applied to the soil during the post-planting and/or post-emergence cropping period in levels sufficient to control a target pest or pathogen without hurting the crop (e.g., tomato, bell pepper, etc.). The composition may also be used on corms, bulbs, or tubers prior to planting and after planting. Animals may be treated at intervals according to pests present (e.g., gastrointestinal nematodes) and environmental conditions (e.g., three weeks after being put to pasture and again three weeks later).

Those working in this field would of course be readily able to determine in an empirical manner which organisms may be killed or eliminated by the composition. Plant pathogenic organisms successfully controlled or eliminated by treatments in accordance with the present invention include, but are not limited to, nematodes and oomycetes; for example, nematodes (e.g. Meloidogyne spp. (root-knot), Xiphinema spp. (dagger), Pratylenchus (lesion), Longidorus spp. (needle), Paratylenchus spp. (pin), Rotylenchulus spp. (reniform), Helicotylenchus spp. (spiral), Hoplolaimus spp. (lance), Paratrichodorus spp. (stubby root), Tylenchorhynchus spp. (stunt), Radopholus spp. (burrowing), Anguina spp. (seed gall), Aphelenchoides spp. (folair), Bursaphelenchus spp. (pinewood), Ditylenchus spp. (stem, bulb, and potato rot), Trichodorus spp., Globodera spp. (potato cyst), Hemicycliophora spp. (sheath), Heterodera spp. (cyst), Dolichodorus spp. (awl), Criconemoides spp. (ring), Belonolaimus spp. (sting), Tylenchulus semipenetrans (citrus). Particular plant pathogens and nematodes controlled or eliminated by application of the composition include, but are not limited to, the following: root-rot pathogens (e.g., Phytophthora spp., Pythium spp., Rhizoctonia spp., Fusarium spp.); vascular wilt pathogens (e.g., Verticillium spp., Fusarium spp.); root-knot and ectoparasitic nematodes (e.g., Meloidogyne spp., Pratylenchus spp., Rotylenchus spp., Tylenchorrhynchus spp., Xiphinema spp.); root lesion nematodes (e.g., Pratylenchus vulnus); ring nematodes (e.g., Circonemella xenoplax); stubby root nematodes (e.g., Paratrichodorus spp.); stem and bulb nematodes (e.g., Ditylenchus dipsaci); cyst nematodes (e.g., Heterodera schachtii); citrus nematodes (e.g., Tylenchulus semipenetrans); and burrowing nematodes (e.g., Radopholus similus). Gastrointestinal nematodes include Haemonchus contortus, Trichostrongylus colubriformis, and Ostertagia circumcincta. Gastrointestinal nematodes and plant parasitic nematodes are very closely related; for example Haemonchus contortus causes gastrointestinal infection. Important plant pathogenic oomycetes include, but are not limited to Phytophthora infestans, Phytophthora ramorum, Phytophthora capsici, Phytophthora nicotianae, Pythium aphanidermatum, Pythium myriotylum, Pythium ultimum, and Hyaloperonospora parasitica. The oomycetes are filamentous protists that belong to the Kingdom Chromista and were once considered fungi, but based on cell wall composition, the dipoild nature of their nuclei, flagella structure and chloroplast endoplasmic reticulum, they are now considered members of a distinct Kingdom. Materials that have fungistatic or fungicidal activity cannot be assumed to have activity against oomycetes.

The composition may be applied to a wide variety of agricultural plants, for example, tomatoes, peppers, carrots, potatoes, strawberries, melons, pineapples, tobacco, bananas, ornamentals, cut flowers, turf/sod, tobacco, trees/seedlings, coffee, orchard crops (e.g., peaches, citrus), and vine crops (e.g., grapes).

In one embodiment, the composition described herein can be sprayed directly on plant matter or mixed with soil to discourage infestation with nematodes, fungi, or oomycetes.

In one embodiment, the composition is packaged in a pressurized gas aerosol can. Common aerosol propellants include butane, isobutane, liquefied natural gas, and propane.

The invention allows for disinfecting surfaces to inactivate pathogenic organisms (e.g., plant pathogens such as nematodes, oomycetes, fungi and viruses) comprising applying the composition to a surface. The step of applying can involve contacting any substrate, which may be or is suspected to be contaminated, with the composition. By substrate it is meant, without limitation, any subject, such as a human or an animal (contact can be in vivo or ex vivo, any article, any surface (e.g., used in production of plants), or any enclosure.

The step of applying can be performed for any amount of time sufficient to inactivate a pathogenic organism (e.g., plant pathogens such as nematodes, oomycetes, fungi and viruses). In one embodiment, inactivation occurs within about 5 minutes to about 10 minutes after initial contact. However, it is understood that when the emulsions are used in a therapeutic context and applied topically or systemically, the inactivation may occur over a longer period of time, for example, 5, 10, 15, 20, 25, 30, 60 minutes or longer after administration.

The step of applying can be performed using any appropriate means of application. For example, compositions can be administered by spraying, fogging, misting, exposure to aerosols, wiping with a wet or saturated cloth or towlette, drenching, immersing.

The term “treatment” or “treating” as used herein covers any treatment of a gastrointestinal disease (caused by gastrointestinal nematodes) in a ruminant animal, particularly haemonchosis, and includes: (i) preventing the disease from occurring in a subject; (ii) inhibiting the disease, i.e., arresting its development; or (iii) relieving the disease, i.e., causing regression of the disease. References in this specification to treatment or treating include prophylactic treatment as well as the alleviation of symptoms. Generally, a therapeutically effective amount of the composition is administered to the ruminant animal. A “therapeutically effective amount” of the composition is a dose sufficient to either prevent or treat gastrointestinal disease (caused by gastrointestinal nematodes) in a ruminant animal to which the composition is administered. The dosages of the composition which can treat or prevent gastrointestinal disease (caused by gastrointestinal nematodes) in a ruminant animal can be determined in view of this disclosure by one of ordinary skill in the art by running routine trials with appropriate controls. Comparison of the appropriate treatment groups to the controls will indicate whether a particular dosage is effective in preventing or treating a disease (e.g., gastrointestinal disease caused by gastrointestinal nematodes in a ruminant animal) used in a controlled challenge. It is understood in the art that the amount of the composition administered should be the amount that is effective to control the particular pathogen or pathogens in question. In addition, the type, size and condition of the host being treated must be taken into consideration. For example, when controlling a pathogen responsible for gastrointestinal disease (caused by gastrointestinal nematodes) in a ruminant animal, the dose will vary depending on the type and size of the ruminant being treated. An effective amount may be achieved by a single dose or multiple dosings. The precise dosage of the composition utilized herein can easily be determined by one skilled in the art given the teaching of this application; for example, one skilled in the art could follow the procedure utilized below. Beyond dosage, an effective administration of the composition according to the present invention will in part depend on the number and timing of the dosages. For example, the composition is typically given once, though multiple administrations of a dosage may be given to an animal, typically at least about 24 hours apart. In some circumstances it may be desirable to administer the composition more than once to the animal. Again, it is believed that the precise combination of dosage and timing will be subject to a wide range of variation and that numerous combinations effective in treating or preventing a disease can be readily established by those of ordinary skill in the art in view of the present disclosure. It is understood that successful gastrointestinal parasite control involves suppression of free-living forms (in fecal pellets and pastures) and infective forms (in the ruminant). It is further understood that when the composition is administered orally, changes in rumen microbial function will occur. In one embodiment, doses effective on free-living and infective parasite forms were not detrimental to degradation of forages (dietary materials) by microorganisms in rumen fluid.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

The following examples are intended only to further illustrate the invention and are not intended to limit the scope of the invention as defined by the claims.

### EXAMPLES

Results of multiple experiments conducted to evaluate the composition for control of soilborne and foliar diseases of horticultural crops are reported herein. The first in vitro plant parasitic nematode study consisted of two experiments run in parallel using treatments of the experimental composition (EC1) and that composition without the hydrogen peroxide component (EC2) from 0% to 10% in 1% increments to study their effectiveness at suppressing root-knot nematode egg viability. EC1 contained 60% v/v distilled water, 10% v/v polysorbate 80, 5% v/v orange valencia oil, 10% v/v orange terpene oil, and 15% v/v of a 35% wt. % hydrogen peroxide solution; EC2 contained EC1: 60% v/v distilled water, 10% v/v polysorbate 80, 5% v/v orange valencia oil, 10% v/v orange terpene oil, and 15% v/v of a 26% wt. % activated oxygen solution (solution of chlorous acid (Na salt), NaCl, Na carbonate, chloric acid (sodium salt), pH 10). The experiment was performed on the laboratory bench and was conducted using suspension of root-knot nematode (Meloidogyne incognita) eggs extracted from tomato and adjusted to contain 1000 eggs/ml of tap water. The two experiments consisted of 11 treatments (untreated control 0%, and 1-10% at 1% increments) each, and each treatment was replicated three times. Each sample was mixed thoroughly through swirling and 2 mL were extracted with a pipettor and put into the counting slide. Egg, live J2 (juvenile stage 2), and dead J2 counts were recorded for each sample and the counts were repeated daily for four days for both experiments. Table 2 shows a summary of the means for remaining eggs and live J2s on day 4 of root knot nematode experiments with experimental composition containing the hydrogen peroxide (EC1) and the experimental composition without the hydrogen peroxide (EC2); means with the same letter were not significantly different.

Results of the root-knot nematode in vitro experiments: The experimental composition had a significant effect on the survival of root-knot nematode juveniles. Within four days of treatment, all juvenile nematodes were surprisingly killed with concentrations of EC1 of 2% or higher. Concentrations of EC2 surprisingly affected a similar level of control at the 6% level. A decrease in the number of eggs remaining with increasing experimental composition concentration was surprisingly evident. Hatching at 1% concentration was inhibited and egg counts at increasing concentrations decreased (without the presence of dead or live nematodes) which indicated the dissolution of the eggs.

The first in vitro plant pathogenic fungi study consisted of a dose response study that included six plant pathogenic fungi and four plant pathogenic oomycetes. These included Phytophthora capsici, Phytophthora nicotianae, Pythium aphanidermatum, Pythium myriotilum, Fusarium oxysporum, Sclerotinia sclerotiorum, Sclerotium rolfsii, Colletotrichum gleosporiodes, Verticillium albo-atrum, and Rhizoctonia solani. 0.7 cm diameter plugs of a 4-6 day old culture of the different fungal isolates were transferred to Petri plates with ¼ potato dextrose agar containing a range of EC1 or EC2 concentrations from 0 to 4%. Fungal radial growth was measured after the 3 rd, 6^{th}, and 9^{th} day of incubation at 26° C. under continuous light. Percent kill was calculated based on radial growth. IC₅₀ values were calculated using the Probit analysis for toxicology. The experiments were designed as a randomized complete block with three replicates. Table 3 shows the summary of IC₅₀ values and confidence intervals for the experimental composition containing hydrogen peroxide (EC1) and the experimental composition without hydrogen peroxide (EC2).

Results of fungal and oomycete dose response studies: EC1 and EC2 surprisingly inhibited mycelia growth of Colletotrichum gleosporioides, Fusarium oxysporum, Sclerotinia sclerotiorum, Sclerotium rolfsii, Rhizoctonia solani, Verticillium albo-atrum, Pythium aphanidermatum, Pythium myriotilum, Phytophthora nicotianae, and Phytophthora capsici in vitro. Both experimental compositions were surprisingly effective in controlling all tested plant pathogenic fungi at concentration ranging from 1 to 4%. EC1 was surprisingly more potent than EC2 for C. gleosporioides, F. oxysporum, P. capsici, R. solani, P. myriotylum, and S. rolfsii. EC2 was surprisingly more potent than EC1 only for S. sclerotiorum and equally effective for P. nicotianae and Pythium aphanidermatum. Probit analysis on sigmoid response curves surprisingly revealed that the minimum concentration required to kill 50% (IC₅₀) of fungal mycelia growth ranged between 0.5 and 1.2% for EC1 and between 0.6 and 2.2 for EC2.

The second series of tests focused on the efficacy of the composition EC1 for control of root-knot nematode (RKN; Meloidogyne spp.) and Phytophthora capsici in vivo. The first experiment was performed in a greenhouse using a 2×2×3 factorial design with the factors being root-knot nematode inoculation (+/−), pre-drench treatment with the composition (+/−), and level of composition post-transplant application (0, 15%, 25% v:v). Six replicates were used per treatment. The treatment numbers and corresponding description follow in Table 1. Tomato plants (FL-47) were transplanted into 4-inch pots following pre-treatment with (nematode +) or without (nematode −) nematode eggs incorporated into the soil. A mixed population of Meloidogyne arenaria and M. incognita eggs were incorporated at the rate of 5500 eggs per pot applied in 50 ml of water. Pre-drenches, where indicated, were applied to flats of seedlings one week prior to transplanting. Plants that were treated with the composition, but not inoculated with nematodes, were used to assess phytotoxicity. Phytotoxicity was rated using a scale of 0-5 with the following descriptions: 0=no damage; 1=few small lesions or burned leaf edge; 2=one to two leaves with large burned areas; 3=three or more leaves with large burned areas; 4=wilted leaves or defoliation; 5=plant mortality. Nematode damage was assessed using the Barker gall rating scale (Barker, K. R., Nematode Extraction and Bioassays, In: An Advanced Treatise on Meloidogyne, vol. 2, Methodology, eds. K. R. Barker, C. C., Carter, and J. N. Sasser, 1985, North Carolina State University, Raleigh, N.C., p. 30) and total egg counts were taken from root systems. Plant growth data, in the form of height and stem diameters, were taken every 7 days until the completion of the experiment 35 days after treatment application. A second greenhouse experiment was conducted to determine if the composition had an effect on Phytophthora blight of bell pepper. This experiment was conducted using soil with zoospores of the causal agent, Phytophthora capsici. Treatments were the same as those for root-knot nematode on tomato and are listed in Table 1. Pepper plants (cv. Enterprise) were evaluated for phytotoxicity and for disease development using the following rating scale of 0-5: 0=no disease; 1=stem constriction or lesion visible; 2=1+lower leaves defoliated; 3=1+2+upper leaves defoliated or flaccid; 4=most leaves flaccid or abscised; 5=plant mortality.

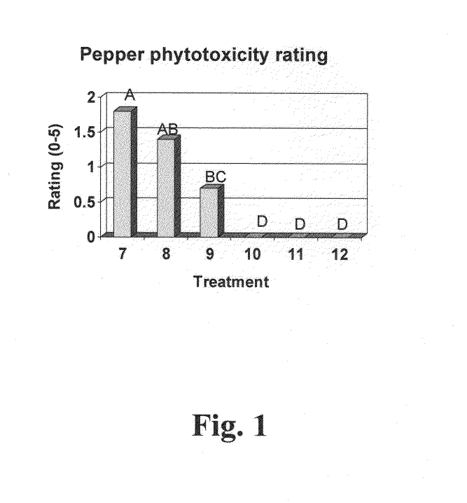

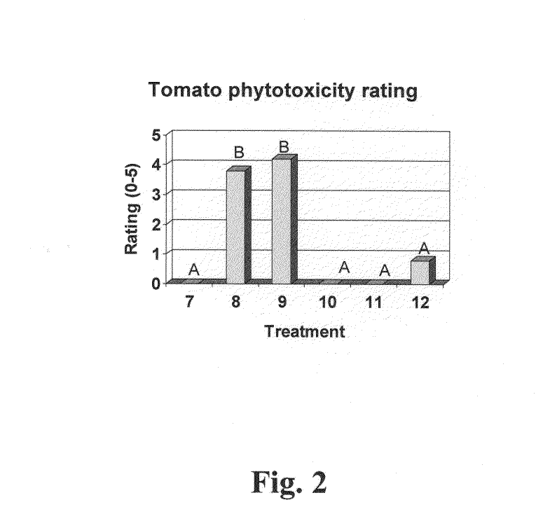

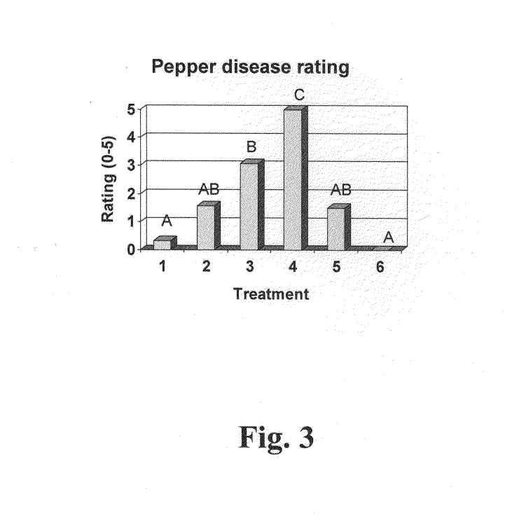

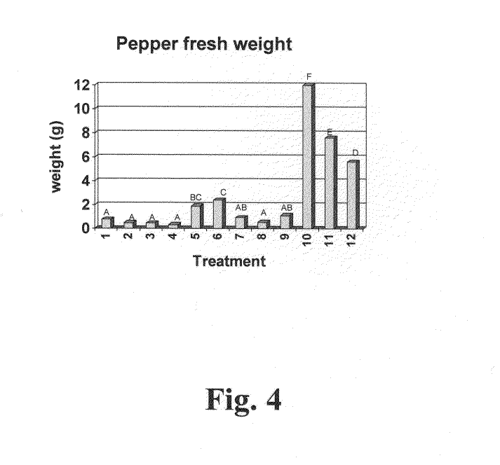

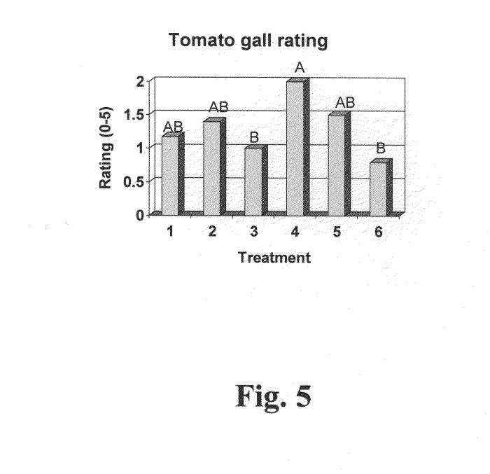

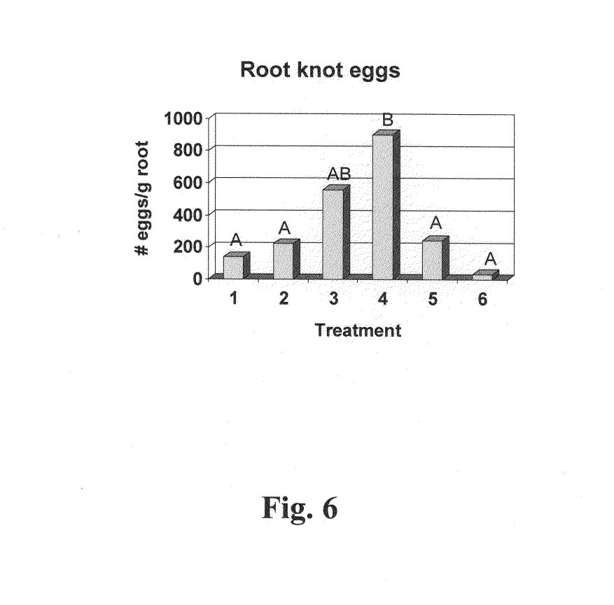

Results of the greenhouse investigations: Composition pre-drenches were found to be phytotoxic to bell pepper even when no post-transplant drench was utilized. There was surprisingly no phytotoxicity when there was no pre-drench application (FIG. 1). Tomato plants were sensitive to the composition if a pre-drench was combined with a post-transplant application, but were surprisingly unaffected when only a post-transplant application was used (FIG. 2). Although it caused phytotoxicity, pre-treatment did surprisingly reduce the severity of Phytophthora blight on pepper. Surprisingly post-transplant treatment with the 25% drench also significantly reduced the severity of this disease and was not a treatment that caused phytotoxicity (FIG. 3). With regard to pepper growth, all treatments containing either the pathogen, or the composition, or the combination, had a significantly negative impact on pepper growth when compared to the untreated control (Treatment 10). An increase in pepper growth was seen with Treatments 5 and 6 when compared to the inoculated untreated control, but these treatments did not result in plant growth that was equivalent to the untreated, uninoculated control (FIG. 4). Surprisingly treatments 3 and 6 significantly reduced the root galling caused by root-knot nematode when compared to the inoculated untreated check (Treatment 4) (FIG. 5), and treatments 1, 2, 5 and 6 all reduced the number of eggs produced per gram of tomato root tissue (FIG. 6). Although there was some phytotoxicity related to the use of the composition, surprisingly a drench of 25% as a post-transplant treatment did provide control of both of the pathogens tested.

The third series of trials was designed to determine the effects of the experimental composition containing hydrogen peroxide (EC1) on embryonation and hatching of gastrointestinal parasite eggs and the motility of infective third-stage parasite larvae (L3). The target organism was Haemonchus contortus derived from infected goats.

H. contortus eggs were isolated from fresh fecal samples collected on ice over a one-hour time period from parasitized goats held in metabolism crates. Aqueous fecal slurries were prepared immediately and filtered through sieves of decreasing pore size. Eggs retained on a 20 μm sieve were purified on a sucrose step gradient (Marquardt, W. C., J. Parasitol., 47: 248-250 (1961)), rinsed with water to remove sucrose, and used to test effects of EC1 on embryonation and hatching. Bioassays were conduced in a 96-well plate with approximately 50 eggs in 70 μL of test solution per well. Water was used as the negative control (100% hatching); a positive control (0% hatching) consisted of a commercial anthelmintic (20% Prohibit® or 20% Ivomec®). Test treatments with EC1 ranged in concentration from 0.1% to 100%. All treatments were replicated eight times. Plates were incubated at 23° C. for 48 hours, then embryonated and non-embryonated eggs were counted. The number of hatched eggs was estimated by difference from the negative control.

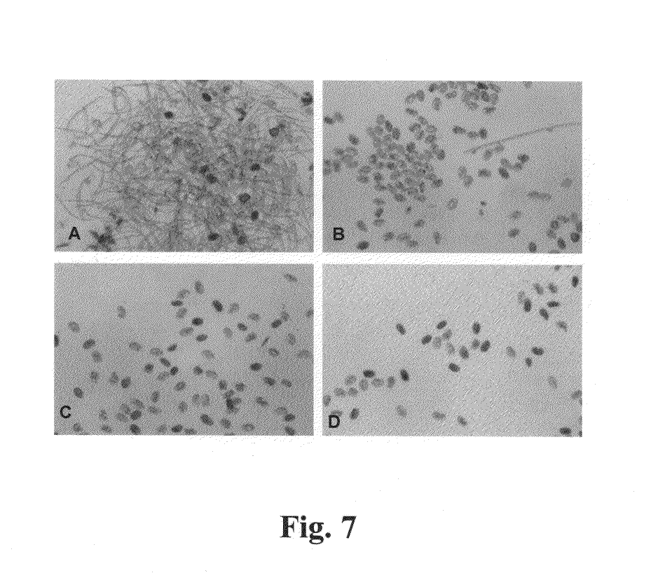

Results of H. contortus embryonation and egg hatching assays: An initial survey with test solutions containing from 2 to 100% EC1 surprisingly indicated that all concentrations prevented at least 90% of eggs from hatching. Microscopic observation after eggs were incubated for 48 hours showed a profusion of worms in the negative control (FIG. 7, panel A). Eggs treated with EC1 surprisingly either failed to embryonate or failed to hatch after embryonating (FIG. 7, panels B, C, and D). Embryonated eggs contained a worm, giving the eggs the appearance of doughnuts. Non-embryonated eggs contained only an amorphous mass. Table 4 summarizes the effects of EC1, at concentrations of 0.1 to 2%, on embryonation and hatching of H. contortus egg in vitro. Surprisingly, complete inhibition of egg hatching occurred when EC1 concentrations were 1 or 2% with approximately 45% of the eggs failing to embryonate. At lower concentrations, more of the eggs (63 to 68%) embryonated and more hatched; however, even at 0.1% EC1, surprisingly only 33% of the eggs hatched.

H. contortus L3 were obtained by incubating egg-laden feces at 25° C. and 80% relative humidity for 14 days, then collecting worms by filtering aqueous suspensions of the fecal cultures through four layers of grade 50 cheesecloth, centrifuging the resulting worm suspension for 10 min at 1200×g, and allowing resuspended worms to migrate through a 25 μm sieve using a Baerman apparatus. Larvae were exsheathed by treatment with 0.16% sodium hypochlorite for 20 min, then transferred to phosphate buffered saline prior to bioassay. The effect of EC1 on L3 motility was determined by incubating 200 L3 in 500 μL of test solutions containing from 1 to 10% EC1. After 2 hours, incubation media containing L3 were transferred to 20 μm sieves. The number of L3 that migrated through the screen and the number retained by the screen were counted 18 hours later, and the percent inhibition of larval migration was calculated using six replicates of each treatment. The LMI₅₀ was estimated by regression analysis. Positive and negative controls were as described for egg embryonation studies.

Results of H. contortus larval migration inhibition assays: Table 5 shows the inhibition of motility of third stage Haemonchus contortus larvae resulting from direct exposure to EC1; larval migration inhibition (LMI) is expressed as a percentage relative to the control. More than 50% inhibition of larval motility occurred when L3 were exposed to EC1 concentrations of 3% or higher; the estimated LMI₅₀ was 3% or less. While this assay does not distinguish between dead and inactive larvae, results indicated that exposure of L3 to 3 to 10% EC1 surprisingly diminished the number of L3 capable of moving into the grazing horizon in a pasture.

Potential adverse effects of EC1 on rumen microorganisms was assessed by measuring the degradation of representative forage species (grass, orchardgrass (Dactylis glomerata L.); legume, alfalfa (Medicago sativa L.); forb, chicory (Cichorium intybus L.)) in the presence of 2% EC1 using in vitro rumen fermentation procedures of Tilley and Terry (Tilley, J. M. A., and R. A. Terry, J. Br. Grassl. Soc., 18: 104-109 (1963)) as modified by Moore (Moore, J. F., Procedures for the two-stage in vitro digestion of forages, p. 501-503, In: Nutrition research techniques for domestic and wild animals, Vol. 1, L. E. Harris (ed.), Utah State Univ., Logan (1970)). Controls included buffer, 0.6% hydrogen peroxide, and 2% soybean oil. Ruminal fluid was obtained from two cannulated steers (Bos taurus) grazing pasture (predominantly orchardgrass) and offered cool-season grass hay (primarily orchardgrass) and alfalfa hay. After incubation, assay tube contents were filtered through crucibles, dried at 105° C., cooled over silica gel desiccant, and reweighed to determine in vitro dry matter disappearance (Goering, H. K., and P. J. Van Soest, Forage fiber analyses (apparatus, reagents, procedures, and some applications), Agric. Handb. 379, U.S. Gov. Print. Office, Washington, D.C., 1970)).

Results of in vitro rumen fermentation assays: Table 6 shows the dry matter disappearance of dried forages during in vitro rumen fermentation assays; for each forage species, means (four replicates) without a common letter differ (P<0.001). Degradation of dry forages by rumen microorganisms was diminished in the presence of 2% EC1 compared to the buffer control; however, dry matter disappearance was equal to (orchardgrass, chicory) or greater than (alfalfa) than that observed in the presence of 2% soybean oil, a dietary supplement often provided in total mixed rations for ruminants (dairy cows) (Bateman, II, H. G., and T. C. Jenkins, J. Dairy Sci., 81: 2451-2458 (1998)). Only with orchardgrass was an effect of hydrogen peroxide evident, and it was less than that for 2% EC1 and comparable to that observed for 2% soybean oil. Results surprisingly indicated that administration of EC1 as an anthelmintic drench will not have an unacceptable effect on rumen function if the final concentration in the rumen is 2%.

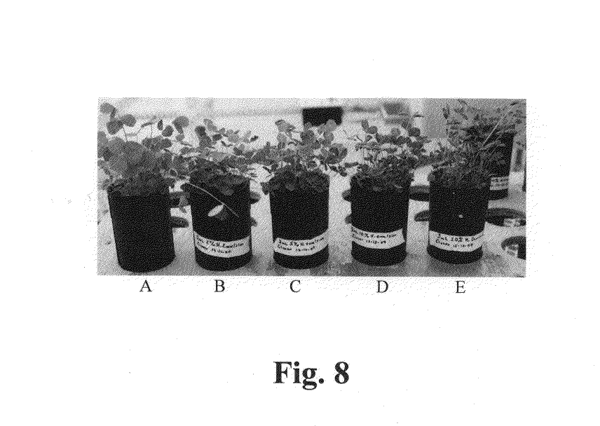

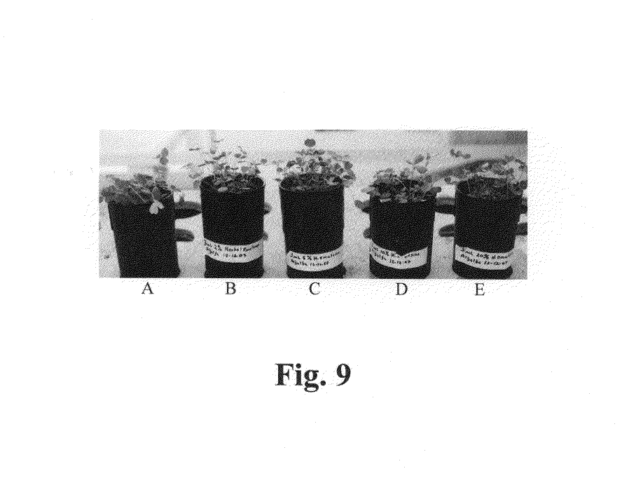

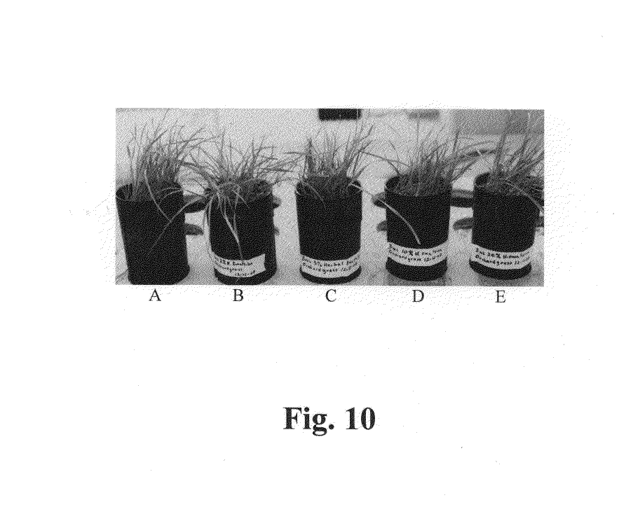

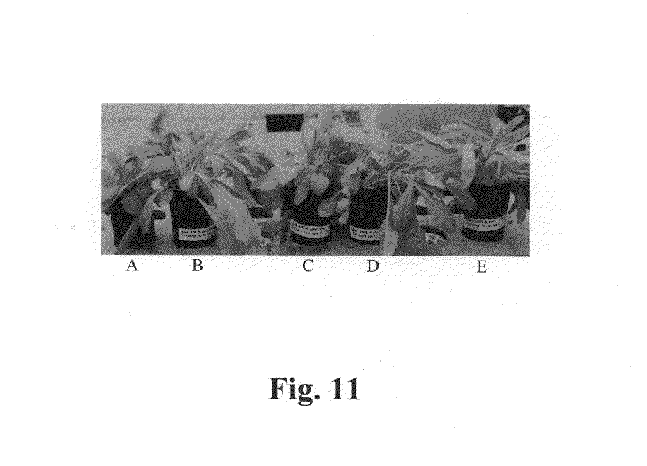

Effects of EC1 on young leaves of four common forage species, alfalfa (‘Alfagraze’), red clover (Triticum pretense L., ‘Cinnamon Plus’), orchardgrass (‘Benchmark Plus’), and chicory (‘Grasslands Puna’) were evaluated using six-week-old, greenhouse-grown seedlings. Plants were seeded in 6.4-cm-top diameter conical containers filled with commercial, organically enriched top soil and top-dressed with 0.25 teaspoon of Osmocote® 19-6-12 slow-release fertilizer. A 14-hour photoperiod was provided using supplemental lighting. Average day/night temperatures were 25/18° C.; relative humidity was 50%. Treatments consisted of 3 mL of 0, 2, 5, 10, or 20% EC1 in water, applied to individual plants with an atomizer. Two days post treatment, surprisingly only red clover seedlings receiving 10 or 20% EC1 showed significant leaf damage (FIGS. 8-11).

Overall results surprisingly support use of EC1 as both an anthelmintic drench for animals and for treatment of pastures contaminated with H. contortus. The limited number of confirmed plant constituents with anthelmintic activity and the absence of any chemical treatment for H. contortus control in pastures make the results reported above surprisingly unique.

It is well known that materials that are fungicidal do not often have nematicidal or anti-oomycete activity. Very few materials are available for nematode or oomycete control and a material identified as a fungicide or bactericide cannot be assumed to have nematicidal or anti-oomycete activity. Thus the results reported above are unexpected.

All of the references cited herein, including U.S. patents, are incorporated by reference in their entirety. Also incorporated by reference in its entirety is U.S. Provisional Application No. 60/720,811 filed Sep. 27, 2005. Also incorporated by reference in its entirety U.S. Pat. No. 7,056,864.

Thus, in view of the above, the present invention concerns (in part) the following:

A method for reducing pests in an object or area, comprising (or consisting essentially of or consisting of) applying to said object or area a pest reducing effective amount of a composition comprising (or consisting essentially of or consisting of) orange terpene oil, orange valencia oil, at least one non-ionic emulsifier, distilled water or deionized water, and optionally hydrogen peroxide (or source of activated oxygen).

The above method, wherein said orange terpene oil is present in said composition from about 5% to about 40% v/v, said orange valencia oil is present in said composition from about 5% to about 40% v/v, said non-ionic emulsifier is present in said composition from about 5% to about 50% v/v, said distilled water or deionized water is present in said composition from about 5% to about 80% v/v, and said hydrogen peroxide is present in said composition from about 1.5% to about 8% w/v hydrogen peroxide.

The above method, wherein said non-ionic emulsifier is polysorbate 80.

The above method, wherein said composition comprises about 5.25% w/v hydrogen peroxide, about 10% v/v orange terpene oil, about 5% v/v orange valencia oil, about 10% v/v polysorbate 80, and about 60% v/v distilled water.

The above method, wherein said composition further comprises oil of rosemary.

The above method, wherein said composition further comprises a surfactant.

The above method, wherein said pests are selected from the group consisting of nematodes, oomycetes, fungi, viruses and mixtures thereof. The above method, wherein said pests are any combination of nematodes, oomycetes, fungi, and viruses.

The above method, wherein said pests are plant pathogens.

The above method, wherein said pests are nematodes.

The above method, wherein said pests are oomycetes.

The above method, wherein said pests are fungi.

The above method, wherein said pests are viruses.

The above method, wherein said pests are gastrointestinal nematodes.

The above method, wherein said object or area is selected from the group consisting of soil, structures, agricultural commodities, plants, surfaces, and mixtures thereof.

The above method, wherein said object or area is soil and wherein said pests are selected from the group consisting of nematodes, oomycetes, fungi, and mixtures thereof.

The above method, wherein said object or area is soil and wherein said pests are selected from the group consisting of nematodes, oomycetes, and mixtures thereof.

The above method, wherein said object or area are surfaces (e.g., used in the production of plants) and wherein said pests are selected from the group consisting of nematodes, oomycetes, fungi, viruses and mixtures thereof.

The above method, wherein said object or area are surfaces (e.g., used in the production of plants) and wherein said pests are viruses.

The above method, wherein said composition does not contain hydrogen peroxide.

The above method, wherein said composition does contain hydrogen peroxide.

The above method, wherein said orange terpene oil is a cold pressed terpene oil comprising a maximum of about 96% limonene.

The above method, wherein said orange terpene oil has a boiling point of about 160-250° C., a flash point of about 50° C., vapor pressure at 20° C. of about 1.2 hPa, a density at 20° C. of about 0.85 g/cm³, and solubility in water about 0.03 g/L.

The above method, wherein said orange valencia oil is a cold pressed orange oil brasil valencia type oil comprising a maximum of about 0.4% linalool, and a maximum of about 95% limonene.

The above method, wherein said orange valencia oil has a flash point of about 450° C., vapor pressure at 20° C. of about 1 hPa, a density at 20° C. of about 0.84 g/cm³, and solubility in water about 0 g/L.

A method for treating gastrointestinal nematode infection in ruminant animals, said method comprising (or consisting essentially of or consisting of) administering to a ruminant animal in need of such treatment a therapeutically effective amount of a composition comprising (or consisting essentially of or consisting of) orange terpene oil, orange valencia oil, at least one non-ionic emulsifier, distilled water or deionized water, and optionally hydrogen peroxide (or source of activated oxygen).

The above method, wherein said composition does not contain hydrogen peroxide.

The above method, wherein said composition does contain hydrogen peroxide.

The above method, wherein said gastrointestinal nematode infection is caused (at least in part) by Haemonchus contortus.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

TABLE 1
Treatment number and corresponding treatment description.

| | Root Knot | | |
|---|---|---|---|
| Treatment | Nematode | pre-drench | composition |
| 1 | y | y | 0 |
| 2 | y | y | 15 |
| 3 | y | y | 25 |
| 4 | y | n | 0 |
| 5 | y | n | 15 |
| 6 | y | n | 25 |
| 7 | n | y | 0 |
| 8 | n | y | 15 |
| 9 | n | y | 25 |
| 10 | n | n | 0 |
| 11 | n | n | 15 |
| 12 | n | n | 25 |

TABLE 2

| | |
|---|---|
| | Day 4 Live J2 |
| Day 4 Egg Count | Count |

| | EC1 | EC2 | EC1 | EC2 |
|---|---|---|---|---|
| Control | 21.67 c | 32.33 c | 5.33 a | 3.33 a |
| 1% | 46.67 a | 40.33 abc | 0.33 b | 2.00 ab |
| 2% | 38.00 ab | 49.33 ab | 0.00 b | 1.00 bc |
| 3% | 40.67 ab | 42.67 abc | 0.00 b | 1.00 bc |
| 4% | 41.00 ab | 36.33 bc | 0.00 b | 0.33 c |
| 5% | 36.67 ab | 43.67 abc | 0.00 b | 0.67 bc |
| 6% | 47.33 a | 40.00 abc | 0.00 b | 0.00 c |
| 7% | 37.67 ab | 50.33 a | 0.00 b | 0.33 c |
| 8% | 32.33 bc | 38.33 abc | 0.00 b | 0.33 c |
| 9% | 46.00 a | 41.33 abc | 0.00 b | 0.00 c |
| 10% | 34.33 b | 35.00 c | 0.00 b | 0.00 c |
| LSD | 10.89 | 13.54 | 0.86 | 1.39 |
| (0.05) | | | | |

TABLE 3

| | |
|---|---|
| EC1 | EC2 |

| | R² | IC₅₀ | R² | IC₅₀ |
|---|---|---|---|---|
| Colletotrichum | 0.8 | 0.8 | 0.87 | 1.7 |
| gleosporioides | | | | |
| Fusarium oxysporum | 0.97 | 1.0 | 0.96 | 2.2 |
| Rhizoctonia solani | 0.90 | 1.3 | 0.94 | 1.5 |
| Sclerotinia sclerotiorum | 0.85 | 1.0 | 0.43 | 0.6 |
| Sclerotium rolfsii | 0.71 | 1.2 | 0.85 | 0.85 |
| Verticillium albo-atrum | 0.87 | 0.9 | 0.95 | 1.5 |
| Phytophthora capsici | 0.99 | 1.3 | 0.94 | 1.5 |
| Phytophthora nicotianae | 0.5 | 0.5 | 0.9 | 1.2 |
| Pythium aphanidermatum | 0.43 | 0.6 | 0.43 | 0.8 |
| Pythium myriotilum | 0.97 | 1.0 | 0.89 | 1.6 |

TABLE 4

| | % Embryonated | % Non-embryonated | % Hatched |
|---|---|---|---|
| Treatment | eggs | eggs | eggs^{a} |
| 20% Ivomec^{b} | 88.86 | 10.68 | 0.46 |
| 2% EC1 | 56.54 | 43.46 | 0.00 |
| 1% EC1 | 55.06 | 44.94 | 0.00 |
| 0.5% EC1 | 68.24 | 15.79 | 15.97 |
| 0.2% EC1 | 62.55 | 1.89 | 35.56 |
| 0.1% EC1 | 66.24 | 0.95 | 32.82 |

^{a}Calculated from the difference between the number of worms in the negative control (water) and the sum of the embryonated and non-embryonated eggs in the test treatment. Values are means for eight replicates.
^{b}Positive control (commercial anthelmintic).

TABLE 5

| Date | EC1 concentration | LMI, %^{a} |
|---|---|---|
| Test 1 | 10% | 81.5 |
| | 7% | 84.4 |
| | 5% | 71.7 |
| | 3% | 57.2 |
| | 1% | 11.3 |
| Test 2 | 10% | 91.3 |
| | 7% | 85.5 |
| | 5% | 83.7 |
| | 3% | 80.6 |
| | 1% | 63.8 |

^{a}Larval migration inhibition.

TABLE 6

| | | Dry matter |
|---|---|---|
| Forage species | Treatment | disappearance, % |
| Alfalfa | Buffer control | 61.3a |
| | 0.6% Peroxide | 57.0a |
| | 2% EC1 | 46.4b |
| | 2% Soybean oil | 37.7c |
| Chicory | Buffer control | 67.2a |
| | 0.6% Peroxide | 63.5a, b |
| | 2% Soybean oil | 39.3b, c |
| | 2% EC1 | 28.1c |
| Orchardgrass | Buffer control | 69.2a |
| | 0.6% Peroxide | 52.8b |
| | 2% Soybean oil | 40.4b, c |
| | 2% EC1 | 35.5c |

We claim:

1. A method for reducing pests in an object or area, comprising applying to said object or area a pest reducing effective amount of a composition comprising orange terpene oil, orange valencia oil, at least one non-ionic emulsifier, distilled water or deionized water, and optionally hydrogen peroxide.

2. The method according to claim 1, wherein said orange terpene oil is present in said composition from about 5% to about 40% v/v, said orange valencia oil is present in said composition from about 5% to about 40% v/v, said non-ionic emulsifier is present in said composition from about 5% to about 50% v/v, said distilled water or deionized water is present in said composition from about 5% to about 80% v/v, and said hydrogen peroxide is present in said composition from about 1.5% to about 8% w/v hydrogen peroxide.

3. The method according to claim 1, wherein said non-ionic emulsifier is polysorbate 80.

4. The method according to claim 3, wherein said composition comprises about 5.25% w/v hydrogen peroxide, about 10% v/v orange terpene oil, about 5% v/v orange valencia oil, about 10% v/v polysorbate 80, and about 60% v/v distilled water.

5. The method according to claim 1, said composition further comprises oil of rosemary.

6. The method according to claim 1, wherein said composition further comprises a surfactant.

7. The method according to claim 1, wherein said pests are selected from the group consisting of nematodes, oomycetes, fungi, viruses and mixtures thereof.

8. The method according to claim 1, wherein said pests are plant pathogens.

9. The method according to claim 1, wherein said pests are nematodes.

10. The method according to claim 1, wherein said pests are oomycetes.

11. The method according to claim 1, wherein said pests are fungi.

12. The method according to claim 1, wherein said pests are viruses.

13. The method according to claim 1, wherein said object or area is selected from the group consisting of soil, structures, agricultural commodities, plants, surfaces, and mixtures thereof.

14. The method according to claim 1, wherein said object or area is soil and wherein said pests are selected from the group consisting of nematodes, oomycetes, fungi, and mixtures thereof.

15. The method according to claim 1, wherein said object or area is soil and wherein said pests are selected from the group consisting of nematodes, oomycetes, and mixtures thereof.

16. The method according to claim 1, wherein said object or area are surfaces and wherein said pests are selected from the group consisting of nematodes, oomycetes, fungi, viruses and mixtures thereof.

17. The method according to claim 1, wherein said object or area are surfaces and wherein said pests are viruses.

18. The method according to claim 1, wherein said composition does not contain hydrogen peroxide.

19. The method according to claim 1, wherein said composition does contain hydrogen peroxide.

20. The method according to claim 1, wherein said orange terpene oil is a cold pressed terpene oil comprising a maximum of about 96% limonene.

21. The method according to claim 1, wherein said orange terpene oil has a boiling point of about 160-250° C., a flash point of about 50° C., vapor pressure at 20° C. of about 1.2 hPa, a density at 20° C. of about 0.85 g/cm³, and solubility in water about 0.03 g/L.

22. The method according to claim 1, wherein said orange valencia oil is a cold pressed orange oil brasil valencia type oil comprising a maximum of about 0.4% linalool, and a maximum of about 95% limonene.

23. The method according to claim 1, wherein said orange valencia oil has a flash point of about 450° C., vapor pressure at 20° C. of about 1 hPa, a density at 20° C. of about 0.84 g/cm³, and solubility in water about 0 g/L.

24. A method for treating gastrointestinal nematode infection in ruminant animals, said method comprising administering to a ruminant animal in need of such treatment a therapeutically effective amount of a composition comprising orange terpene oil, orange valencia oil, at least one non-ionic emulsifier, distilled water or deionized water, and optionally hydrogen peroxide.

25. The method according to claim 24, wherein said composition does not contain hydrogen peroxide.

26. The method according to claim 24, wherein said composition does contain hydrogen peroxide.

27. The method according to claim 24, wherein said gastrointestinal nematode infection is caused by Haemonchus contortus.
